(19) United States
(12) Patent Application Publication
(10) Pub. No.: US 2007/0083345 A1
(43) Pub. Date: Apr. 12, 2007

(54) Method and apparatus for reducing gyro aliasing, noise, and quantization

(75) Inventor: Richard A. Fowell, Rolling Hills Estates, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: The Boeing Company

(21) Appl. No.: 11/247,644

(22) Filed: Oct. 10, 2005

(51) Int. Cl. G06F 15/00

(52) U.S. Cl. 702/190

(57) ABSTRACT

A method and apparatus for filtering sensor measurements is disclosed. The method comprises the steps of digitally integrating the sensor measurements at a first processing rate to produce a first intermediate signal, digitally integrating the first intermediate signal at the first processing rate to produce a second intermediate signal, sampling the second intermediate signal at a second processing rate to produce a third intermediate signal, digitally differentiating the third intermediate signal at the second processing rate to produce a fourth intermediate signal, and digitally differentiating the fourth intermediate signal at the second processing rate to produce filtered sensor measurements.

### BACKGROUND OF THE INVENTION

1. Field of the Invention

The present invention relates to systems and methods for processing sensor measurements, and in particular to a system and method for filtering sensor measurements to prevent aliasing.

2. Description of the Related Art

Sensors (including gyros and accelerometers) are used to provide information for the flight control of both spacecraft and aircraft. The output of such sensors are typically sampled and provided as an input to the flight processor of the spacecraft or aircraft. Unfortunately, such sensors often detect structural mode vibrations and noise. When such vibrations and harmonics are near gyro sample frequency harmonics, they can be aliased down in frequency to bandwidths near those of the flight control system. In addition, some gyro technologies have an inherent quantization limit in their integrated rate signal. This inherent quantization limit can be another source of aliased noise, because the quantization noise is transmitted at the sample frequency.

These aliased components compromise flight control system performance, and are therefore undesirable. For example, aliased noise and vibrations can cause attitude control problems such as (1) noisy attitude and angular rate measurements (2) noisy control response with increased jitter and power or fuel consumption, and (3) feedback destabilization of modes near harmonics of the sample rate.

This problem can be ameliorated by use of sensor-internal anti-aliasing filters. For example, anti-aliasing filters can be implemented in a gyro to filter the integrated angular rate for each of the three orthogonal axes. This is often accomplished with the use of one to five cascaded moving average, or “sinc” filters to produce a decimated output at a much lower rate (e.g. 100 or 200 Hz) than the rate integration rate (≧1000 Hz). The decimated output is then back-differenced in the gyro to produce the integrated angle information. The integrated angle is typically asynchronously sampled at a higher rate by a sampler or a flight computer. The problem with such an implementation is that the anti-aliasing filter has a first zero at a frequency that (1) it is inconsistent with the flight computer sampling and processing rate, (2) the integrated angle information is typically buffered, and integrated angle information is typically output at a fairly low rate (e.g. 100 Hz), the buffer adds a significant amount of data latency and jitter, and (2) the anti-aliasing filter requires at least two delay registers in the gyro.

Furthermore, data from the above described sensors may be used by different subsystems and for different purposes. For example, the output of a gyro may be used to stablilize the spacecraft as well as to stabilize and point a payload mounted on the spacecraft, or to provide attitude data for other purposes. Each of these processes may also require different signal characteristics (i.e. sampling rate, and differently located poles and zeros created by the respective integration and back differencing processes). Sensors with built-in anti-aliasing filters disadvantageously provide all data users with identical signal characterisitcs.

What is needed is a system and method for anti-aliasing sensor outputs that manifests zeros that are consistent with flight computer processing rates, reduces data latency and jitter, and minimizes demands on gyro hardware. What is also needed is a system and method for providing anti-aliased sensor data in a way that permits optimal use by a wide variety of subsytems with different signal requirements. The present invention satisfies these needs.

### SUMMARY OF THE INVENTION

To address the requirements described above, the present invention discloses a method and apparatus for filtering sensor measurements. The method comprises the steps of digitally integrating the sensor measurements at a first processing rate to produce a first intermediate signal, digitally integrating the first intermediate signal at the first processing rate to produce a second intermediate signal, sampling the second intermediate signal at a second processing rate to produce a third intermediate signal, digitally differentiating the third intermediate signal at the second processing rate to produce a fourth intermediate signal, and digitally differentiating the fourth intermediate signal at the second processing rate to produce filtered sensor measurements. The apparatus comprises a sensor, for measuring a dynamic parameter subject to aliasing, the sensor including a first digital integrator for integrating sensor measurements at a first processing rate, an anti-aliasing filter, and a navigation or flight processor. The anti-aliasing filter comprises a second digital integrator implemented in the sensor, operating at the first processing rate, a sampler, communicatively coupled to the second digital integrator, operating at a sampling rate, and a first differentiator, external to the sensor, operating at a second processing rate. The navigation processor includes a second differentiator communicatively coupled to the first digital back differencer.

### BRIEF DESCRIPTION OF THE DRAWINGS

Referring now to the drawings in which like reference numbers represent corresponding parts throughout:

FIG. 1 is a diagram of a three-axis stabilized spacecraft;

FIG. 2 is a diagram depicting the functional architecture of a representative attitude control system for the spacecraft;

FIG. 3 is a block diagram illustrating the functional interface between a typical sensor such as a rate integrating gyro and a flight or navigation computer;

FIG. 4 is a diagram showing the conventional application of an anti-aliasing filter to a rate integrating gyro;

FIGS. 5A and 5B are diagrams illustrating one embodiment of an improved anti-aliasing filter;

FIG. 5C is a diagram illustrating a system that can handle the overflow/underflow problem with uninterrupted antialias filtering service at a penalty of as little as two bits per signal; and

FIG. 6 is a diagram illustrating another embodiment of the present invention.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

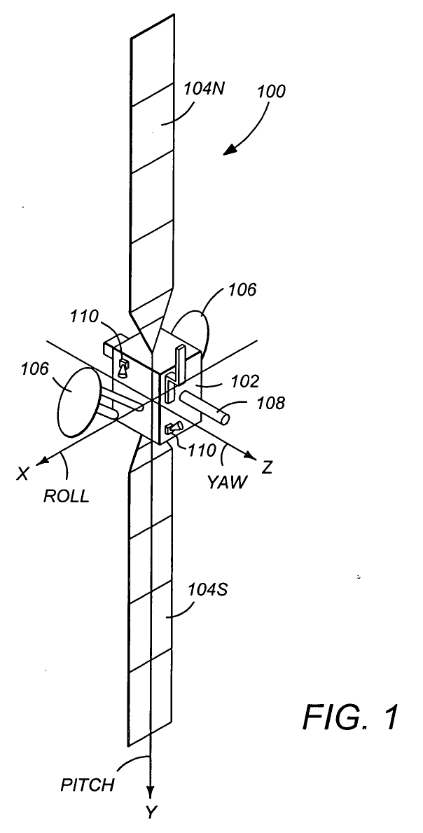

FIG. 1 illustrates a three-axis stabilized satellite or spacecraft 100. The spacecraft 100 is preferably situated in a stationary orbit about the Earth. The satellite 100 has a main body 102, a pair of solar panels 104, a pair of high gain narrow beam antennas 106, and a telemetry and command omni-directional antenna 108 which is aimed at a control ground station. The satellite 100 may also include one or more sensors 110 to measure the attitude of the satellite 100. These sensors may include sun sensors, earth sensors, and star sensors. Since the solar panels are often referred to by the designations “North” and “South”, the solar panels in FIG. 1 are referred to by the numerals 104N and 104S for the “North” and “South” solar panels, respectively.

The three axes of the spacecraft 100 are shown in FIG. 1. The pitch axis Y lies along the plane of the solar panels 104N and 104S. The roll axis X and yaw axis Z are perpendicular to the pitch axis Y and lie in the directions and planes shown. The antenna 108 points to the Earth along the yaw axis Z.

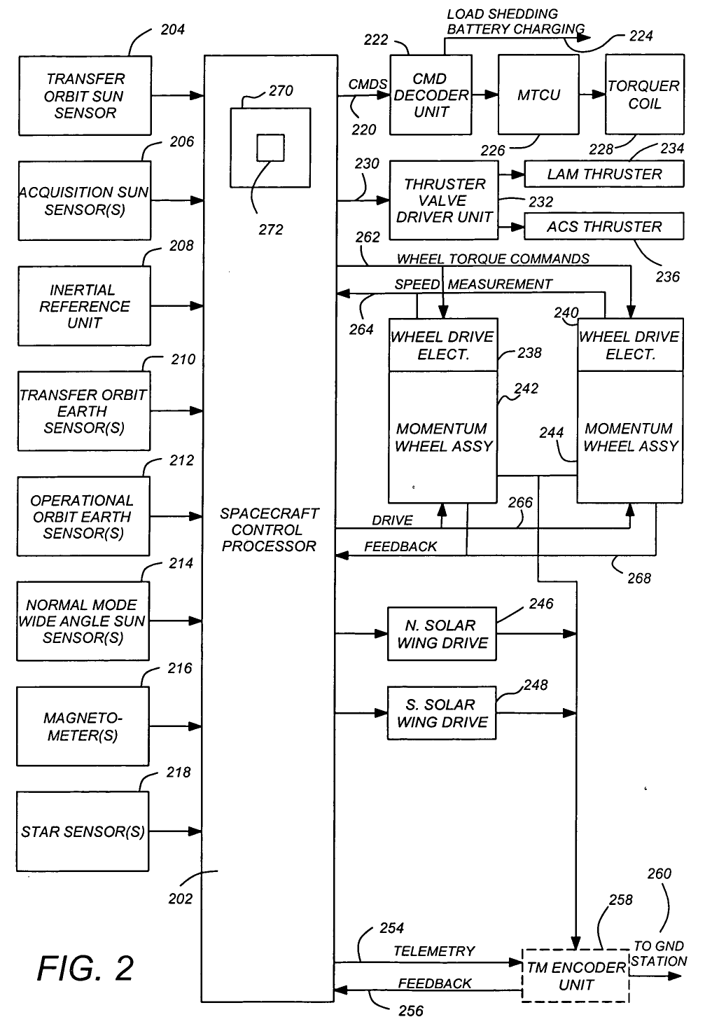

FIG. 2 is a diagram depicting the functional architecture of a representative attitude control system. Control of the spacecraft is provided by a computer or spacecraft control processor (SCP) 202. The SCP performs a number of functions which may include post ejection sequencing, transfer orbit processing, acquisition control, stationkeeping control, normal mode control, mechanisms control, fault protection, and spacecraft systems support, among others. The post ejection sequencing could include initializing to ascent mode and thruster active nutation control (TANC). The transfer orbit processing could include attitude data processing, thruster pulse firing, perigee assist maneuvers, and liquid apogee motor (LAM) thruster firing. The acquisition control could include idle mode sequencing, sun search/acquisition, and Earth search/acquisition. The stationkeeping control could include auto mode sequencing, gyro calibration, stationkeeping attitude control and transition to normal. The normal mode control could include attitude estimation, attitude and solar array steering, momentum bias control, magnetic torquing, and thruster momentum dumping (H-dumping). The mechanisms mode control could include solar panel control and reflector positioning control. The spacecraft control systems support could include tracking and command processing, battery charge management and pressure transducer processing.

Input to the spacecraft control processor 202 may come from a any combination of a number of spacecraft components and subsystems, such as a transfer orbit sun sensor 204, an acquisition sun sensor 206, an inertial reference unit 208, a transfer orbit Earth sensor 210, an operational orbit Earth sensor 212, a normal mode wide angle sun sensor 214, a magnetometer 216, and one or more star sensors 218.

The SCP 202 generates control signal commands 220 which are directed to a command decoder unit 222. The command decoder unit operates the load shedding and battery charging systems 224. The command decoder unit also sends signals to the magnetic torque control unit (MTCU) 226 and the torque coil 228.

The SCP 202 also sends control commands 230 to the thruster valve driver unit 232 which in turn controls the liquid apogee motor (LAM) thrusters 234 and the attitude control thrusters 236.

Wheel torque commands 262 are generated by the SCP 202 and are communicated to the wheel speed electronics 238 and 240. These effect changes in the wheel speeds for wheels in momentum wheel assemblies 242 and 244, respectively. The speed of the wheels is also measured and fed back to the SCP 202 by feedback control signal 264.

The spacecraft control processor also sends jackscrew drive signals 266 to the momentum wheel assemblies 242 and 244. These signals control the operation of the jackscrews individually and thus the amount of tilt of the momentum wheels. The position of the jackscrews is then fed back through feedback signal 268 to the spacecraft control processor. The signals 268 are also sent to the telemetry encoder unit 258 and in turn to the ground station 260.

The spacecraft control processor (202) also sends command signals 254 to the telemetry encoder unit 258 which in turn sends feedback signals 256 to the SCP 202. This feedback loop, as with the other feedback loops to the SCP 202 described earlier, assist in the overall control of the spacecraft. The SCP 202 communicates with the telemetry encoder unit 258, which receives the signals from various spacecraft components and subsystems indicating current operating conditions, and then relays them to the ground station 260. The SCP 202 also sends signals to solar wing drivers 246 and 248 to manipulate the orientation of the solar wings 104N, 104S.

The wheel drive electronics 238, 240 receive signals from the SCP 202 and control the rotational speed of the momentum wheels. The jackscrew drive signals 266 adjust the orientation of the angular momentum vector of the momentum wheels. This accommodates varying degrees of attitude steering agility and accommodates movement of the spacecraft as required.

The SCP 202 may include or have access to memory 270, such as a random access memory (RAM). Generally, the SCP 202 operates under control of an operating system 272 stored in the memory 270, and interfaces with the other system components to accept inputs and generate outputs, including commands. Applications running in the SCP 202 access and manipulate data stored in the memory 270. The spacecraft 100 may also comprise an external communication device such as a satellite link for communicating with other computers at, for example, a ground station. If necessary, operation instructions for new applications can be uploaded from ground stations.

In one embodiment, instructions implementing the operating system 272, application programs, and other modules are tangibly embodied in a computer-readable medium, e.g., data storage device, which could include a RAM, EEPROM, or other memory device. Further, the operating system 272 and the computer program are comprised of instructions which, when read and executed by the SCP 202, causes the spacecraft processor 202 to perform the steps necessary to implement and/or use the present invention. Computer program and/or operating instructions may also be tangibly embodied in memory 270 and/or data communications devices (e.g. other devices in the spacecraft 100 or on the ground), thereby making a computer program product or article of manufacture according to the invention. As such, the terms “program storage device,” “article of manufacture” and “computer program product” as used herein are intended to encompass a computer program accessible from any computer readable device or media.

### Rate Integrating Gyros

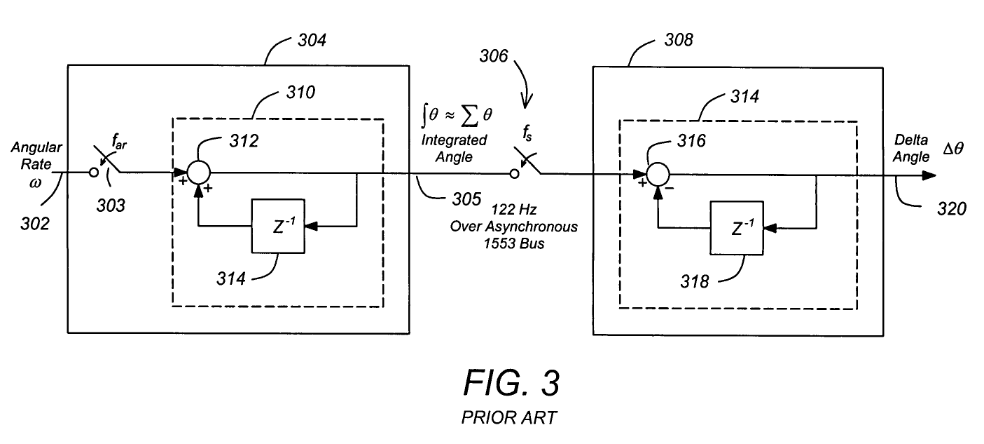

FIG. 3 is a block diagram illustrating the functional interface between a typical sensor such as a rate integrating gyro (RIG) 304 and a flight/navigation computer/processor 308, which can be implemented in the SCP 202.

Typically, the spacecraft 100 is attitude stabilized in three orthogonal directions, and hence, at least three sensors, each sensing mutually orthogonal dynamics, are utilized. In such embodiments, the sensor-flight computer interface includes three channels, each of which are as shown in FIG. 3.

The RIG 304 accepts dynamic input in the form of a rate of angular displacement 302 (e.g. ω (radians/sec)), and provides an output 305 that is an angle (e.g. θ (radians)). The output angle 305 is produced by integrating the sensed angular rate 302 (e.g. θ(t)=∫ω(t)dt). This is typically performed by digitally integrating the angular rate 302 by a digital integrator 310. The digital integrator 310 is typically implemented by feeding back and adding a delayed version of the output to the input angular rate signal 302. The digital integrator 310 shown in FIG. 3 includes a delay element 314 coupled to the output signal 305, which provides a delayed output signal. The delayed output signal is summed with the input angular rate 302 by summer 312 and provided as the output signal 305. The digital integrator 310 typically operates at the processing rate f_{process}^{gyro} of the rate sensor (typically, between about 1,000 and 80,000 Hz), but may operate at lower or higher rates.

The integrated angle 305 is made available in the spacecraft 100 at the processing rate f_{process}^{gyro} over an inter-subsystem communications bus such as a 1553 bus. The sampler 306 asynchronously samples the output signal 305 at a sampling rate fₛ, and provides the sampled output signal to the flight computer 308. In one embodiment, the sampler 306 is inherent or incorporated within the flight computer 308.

The sampling rate fₛ is typically much less than that of the gyro integration processing rate f_{process}^{gyro}. As will be discussed further below, this lower sampling rate can cause aliasing of higher frequency components (including body bending modes and vibrations above the sampling rate fₛ) into lower frequency ranges where they can negatively affect the performance of the flight control system. The flight computer 308 includes a back differencer 314 that computes a delta angle (e.g. Δθ=θᵢ−θᵢ₋₁) from the sampled output signal. This is typically accomplished at flight computer processing rate f_{process}^{computer}, which is typically the same as the sampling rate fₛ. The back differencer 314 shown in FIG. 3 is implemented by a delay element 318 coupled to the output and a differencer 316 coupled to the output of the delay element 318. The computed delta angles 320 are used to update an estimate of the attitude of the spacecraft 100. This can be accomplished, for example, by non-linear strapdown equations using the delta angles 320.

The foregoing process of integration, sampling, and back differencing can be viewed as a “cascaded integrator comb” or “Hogenauer” decimation filter. Such a filter generally consists of a number of high processing rate digital integrators followed by sampling at a lower rate, and a number of numerical differentiators (or back-differencers) equal to the number of the integrators to recover the delta angle information.

This problem is conventionally attacked with the use of high frequency digital anti-aliasing filters inside the gyro 304 itself (see, for example Mark, J. G. and Tazartes, D. A., “Tuning of Coning Algorithms to Gyro Data Frequency Response Characteristics”, Journal of Guidance, Controls, and Dynamics, Vol. 24, No. 4, July-August 2001, pp. 641-647, and U.S. Pat. No. 6,219,616, issued to Litmanovich et al., which are hereby incorporated by reference herein).

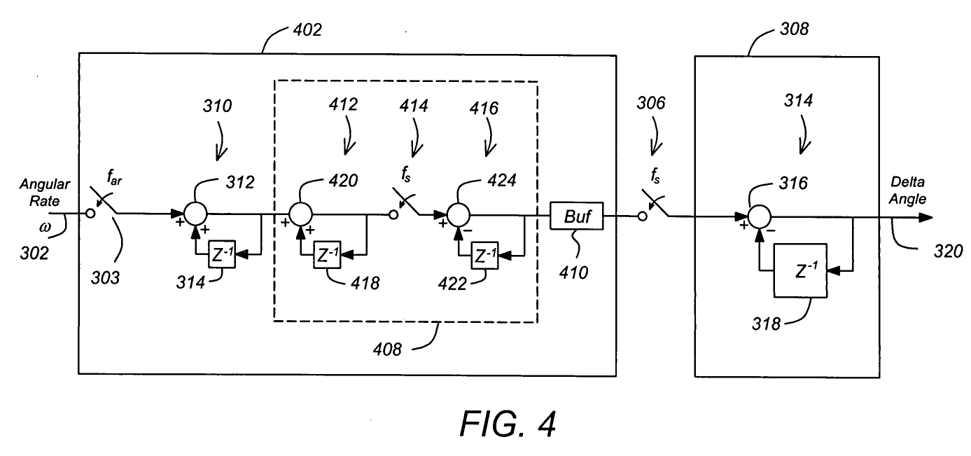

FIG. 4 is a diagram showing the conventional application of an anti-aliasing filter to a RIG 402. Here, an anti-aliasing filter 408 is inserted after the digital integrator 310, and the results of the anti-aliasing filter 408 are temporarily stored in a buffer 410 before being output by the RIG 402. The anti-aliasing filter 408 can comprise one or more cascaded “sinc” filters to produce a decimated output at a much lower frequency (typically about 100 Hz) than the processing rate f_{process}^{gyro} of the digital integrator 310. In the embodiment illustrated in FIG. 4, a single sinc filter is implemented as a Hogenauer filter.

The anti-aliasing filter accepts the output of the digital integrator, which as described above, typically operates at the same processing rate as the digital integrator 310. This signal is further integrated by integrator 412, again typically at the rate of the first digital integrator 310, sampled by sampler 414 at about 100 Hz, and back-differenced at about a 100 Hz processing rate by differencer 416. The resulting signal is buffered by buffer 410, and asynchronously sampled by sampler 306 for use by the navigation processor 308.

Unfortunately, the anti-aliasing filter 408 has a first zero at 100 Hz instead of the preferable frequency of 122 Hz. Furthermore, the 100 Hz sampler 414 adds an average of 5 milliseconds of data latency to the RIG 402 data output, plus 5 milliseconds of latency jitter.

Such filters are resource intensive in gyros using field programmable gate array (FPGA) processing, and can add unnecessary latency. Gyro processing implemented in FPGA form is typically tight for gate resources, and putting all of the processing required for anti-aliasing in the gyro itself exacerbates that problem, as the anti-aliasing filter 408 requires two delay registers 418 and 422 and two summers 420 and 424 in the RIG 402 itself. N-sample moving average filters can be implemented with the aid of an N-sample circular buffer, as described in U.S. Pat. No. 5,485,273, issued to J. G. Mark et al., (which is hereby incorporated by reference herein). However, as noted in the '273 patent, this approach requires a large amount of data storage, which is hard to come by in an FPGA. To reduce the hardware requirements, the '273 patent suggests an alternative implementation (shown in FIG. 3 of the '273 patent) in which the moving average is produced at a decimated rate by summing N samples of the integrated rate at a high sample rate, fₛ, then sampling this sum at the lower rate of fₛ/N, and back differencing the samples. When this is contrasted to simply sampling the integrated rate at fₛ/N, one sees that the new fₛ/N output is the average value of the integrated rate over the prior N high rate fₛ samples. This thus acts as a “moving average” or “sinc” filter, and can be viewed as a digital integrator followed by an N-fold decimator, followed by a digital differentiator. This, however, introduces a latency of roughly N/2 samples at fₛ, and the gyro output is only updated at the lower fₛ/N rate. This means that if the user samples the output asynchronously (typically in many spacecraft 1553 interfaces), there is an additional latency of between zero and one fₛ/N period, above and beyond the half period latency discussed above, effectively doubling the latency penalty of the simple sinc filter.

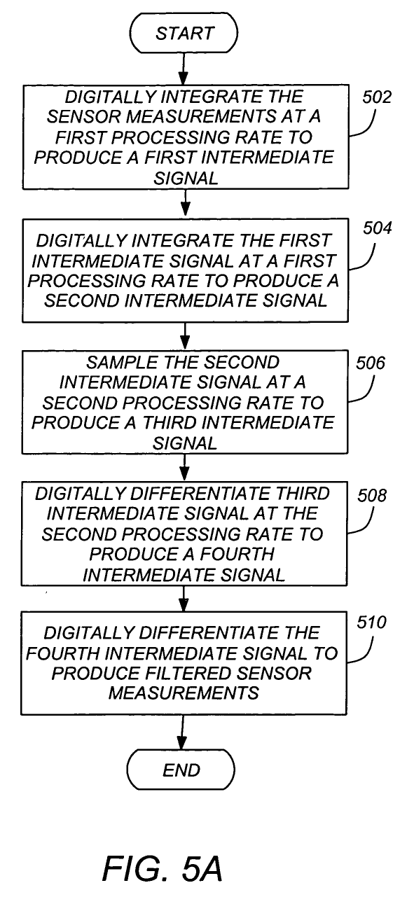

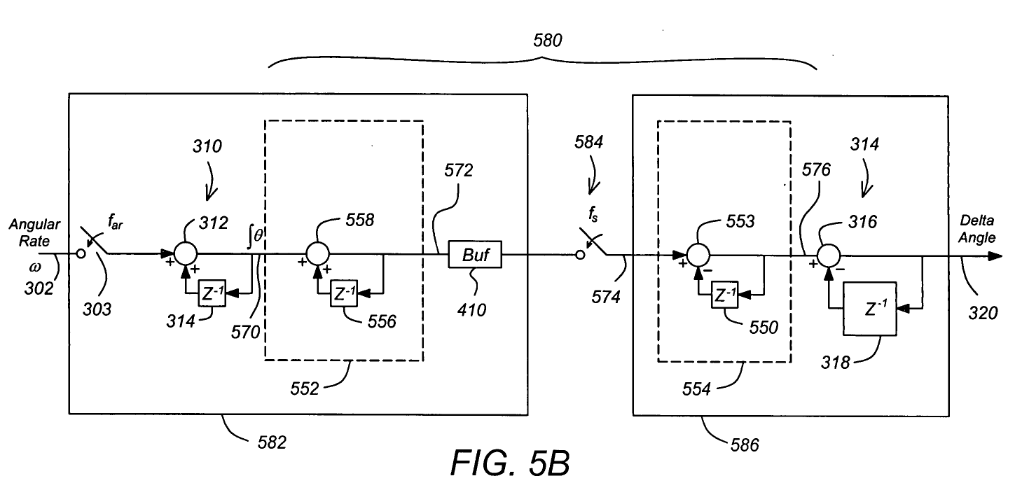

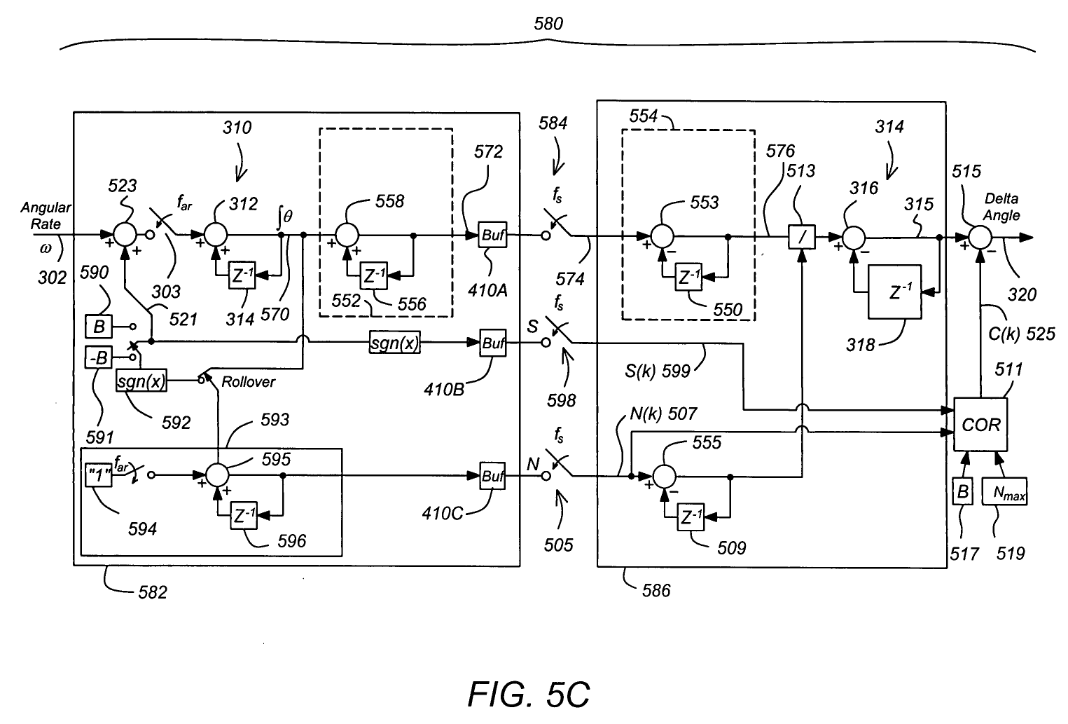

FIGS. 5A and 5B are diagrams illustrating one embodiment of an improved anti-aliasing filter. FIG. 5A presents a flow chart illustrating a method for improved anti-aliasing, and FIG. 5B presents a diagram illustrating one embodiment of an improved anti-aliasing filter that can be used to implement the method shown in FIG. 5A.

Referring first to FIG. 5A, sensor measurements such as a measurement of the angular rate 302 is digitally integrated at a first processing rate to produce a first intermediate signal 570, as shown in block 502. This can be accomplished via the first digital integrator 310, as shown in FIG. 5B. The first intermediate signal 570 is then provided to an anti-aliasing filter 580. In the embodiment shown in FIG. 5B, the anti-aliasing filter 580 is formed by second digital integrator 552 in the sensor (such as a RIG) 582, a sampler 584 which may be implemented internal or external to a processor 586 accepting the sensor data, and first differentiator 554 (implemented as digital back differencer), which is implemented in the processor 586.

The first intermediate signal 570 provided to the second digital integrator 552 is digitally integrated to produce a second intermediate signal 572, as shown in block 504. Preferably, the first intermediate signal 570 is digitally integrated at the at the first processing rate, but a different processing rate may be used as well. The digital integration of the first intermediate signal 570 can be accomplished using the second digital integrator 552 shown in FIG. 5B. In the illustrated embodiment, the second digital integrator 552 is similar in design to that of the first digital integrator 310, that is, it includes a delay element 556 in a feedback path and a summer 558 which sums the input signal an the delayed output provided by the delay element.

The second intermediate signal 572 is then optionally stored by buffer 410, and sampled at a second processing rate fₛ to produce a third intermediate signal 574, as shown in block 506. In the embodiment shown in FIG. 5B, this is illustrated by sampler 404. Although sampler 584 is illustrated as separate from the processor 586, the sampling operation may be inherent in the processor 586 itself Typically, after buffering, the information from the RIG 582 is provided to a system data bus compliant with a 1553 standard, and the processor 586 samples the information at the sampling rate fₛ.

The sampled second intermediate signal, or third intermediate signal 574, is differentiated to produce a fourth intermediate signal 576, as shown in block 508. In the embodiment illustrated in FIG. 5B, this is accomplished via a differentiator such as a digital back differencer 554 having a delay element 550 and a differencer 553. By virtue of the digital integration performed by the digital integrator 552 in the RIG 582 at the first processing rate, sampling by the sampler 584 at a second rate lower than the first processing rate, and the digital differentiation performed by the digital back-differencer 554, the angle information provided by the first integrator 310 is anti-alias filtered. To produce filtered sensor measurements in the form of recovered delta angle information, the fourth intermediate signal 576 is differentiated, as shown in block 510. In the embodiment show in FIG. 5B, this is accomplished via the digital back-differencer 314.

While beneficial to have the processing rate of the processor 586 to be equivalent to that of the sampler 584, this need not be the case. The processor 586 may operate at a higher processing rate than the sampler's 584 sampling rate fₛ (e.g. oversampling) or, if the information is provided to the system bus at a higher rate than that which is required by the processor 586, the flight processor may operate at processing rate that is slower than the sampler's 584 sampling rate fₛ (e.g. undersampling).

Although the foregoing illustrates an antialiasing filter having only one digital integrator 552 and associated differentiator 554, the present invention can be implemented with a plurality of cascaded digital integrators and back differencers as well. For example, the output of the second digital integrator 552 can be provided to another digital integrator before being sampled by the sampler 584, and to remove this additional integration, the output of the back differencer 554 can be provided to another back differencer to complete the antialias filtering process. Hence, it is to be understood that the in the foregoing discussion, the first intermediate signal 570 may undergo additional processing (e.g. from further digital integration) before being supplied to the sampler 584).

Additional “stages” of digital integrators and associated differentiators can increase the order of the “sinc” filtering provided, thus increasing the attenuation in the neighborhood of the harmonics of the sampling frequency fₛ, though such an implementation would also increase latency and low frequency gain reduction.

The digital integrator and differencer can also be implemented as hardware elements or a processor executing software/firmware instructions for performing the required operations. For example, digital integrators can be created by implementing the following equation in a digital processor such as the SCP 202,
output(i)=input(i)+output(i−1) Equation (1)
and digital back differencers may be created by implementing the equation
output(i)=input(i)−output(i−1) Equation (2)
wherein i is an incremental counter.

Since the output of the differentiator or digital differencer 554 is computed by taking the difference between samples, the difference must be scaled by a factor proportional to the time interval between samples. This may be accomplished by:

(1) Computing the difference between the successive integrated samples and dividing that difference by the difference in time between the successive integrated samples, for example, by computing

$${θ}_{k} = \frac{( \int {θ}_{k} - \int {θ}_{k - 1} )}{[ {T}_{k} - {T}_{k - 1} ]} . \qquad Equation ( 3 )$$

(2) In place of the actual difference in time between successive integrated samples, using a time interval [Tₖ-Tₖ₋₁] rounded to the nearest summation period of the digital integration process.

(3) In place of the actual difference in time between successive integrated samples, using a difference in a modulo counter N used in the computation of ∫θ as Σθ, for example, by computing

$${θ}_{k} = \frac{( \int {θ}_{k} - \int {θ}_{k - 1} )}{[ {N}_{k} - {N}_{k - 1} ]} . \qquad Equation ( 4 )$$

(4) In place of the actual difference in time between successive integrated samples, using a value ΔT equal to the nominal user sampling period, or 1/fₛ.

In FIG. 5B, signals 570 and 572 are preferably implemented as finite word length binary integers in two's complement form. In this case, when signal 572 overflows its word length, the two's complement difference at point 576 appropriately recovers the filtered version of signal 570, as long as the sampling rate of sampler 574 is sufficiently high such that the value of 572 moves less than half of the finite word length representation between samples. This approach can be used to handle register overflow systems such as the system illustrated in FIG. 3.

### Handling of Underflow and Overflow Conditions

When the sensor behavior is such that signal 570 cannot overflow or underflow, the processing depicted in FIG. 5B suffices. However, when signal 570 overflows or underflows between samples, the accumulation at summing point 558 is a sum of overflowed and nonoverflowed integers. In this case, the output 576 may take on almost any point in the finite wordlength respresentation, depending on the ratio of overflowed to non-overflowed integers in the sum. Since the desired value for signal 576 is a smoothed version of signal 570, rather than a nearly arbitrary number, this is undesirable. It is preferred for the signal 576 to take on a value in the range of values that signal 570 passed through between samples.

Depending on the amount of continuity desired in the signal 576, the overflow of signal 570 can be handled in different ways.

For cases where the output 570 can overflow or underflow, a simple solution for overflow is to provide the integrated signal 570 as well as the doubly integrated signal 572 at the output 410. When signal 570 has not overflowed since the last sample, the filtered angle 576 can be determined as shown above (e.g. Equation (3) or Equation (4)). If the signal 570 has overflowed or underflowed since the prior sample, then an appropriate value for the input to the summing junction 316 can be determined from the unfiltered signal 570. For example, the interpolated value between the last two samples of signal 570 can be used:
θ_{filtered}_{ₖ}=θₖ₋₁+0.5(θₖ-θₖ₋₁) Equation (5)

Wherein θ_{filtered}_{ₖ} is the input to summing junction 316, and θₖ is the k^{th} sample of signal 570 at sample frequency f.

A further issue is that it might not be possible to detect that an overflow or underflow in signal 570 has occured simply by examining the successive decimated samples produced at sample rate fₛ if an equal number of overflows and underflows has occured between the decimated samples. However, in the case of an equal number of overflows and underflows, there is still the possibility that the output of summing junction 552 is nearly arbitrary. If buffer 410 is being sampled by only one user, this can be detected by providing a bit in buffer 410 that is set whenever signal 570 overflows or underflows, and is reset when the buffer 470 is sampled. This bit can then used to determine whether the input to summing junction 316 is determined by Equation (5) or not. If the sensor is to be used by multiple users, then a rollover overflow/underflow counter can be provided in buffer 410, with a large enough range to count at least the number of overflows and underflows that can occur between successive samples from a given user. The user can then check to determine if the counter has changed since the last sample to determine whether Equation (5) is used to determine the input to summing junction 316 or not.

The overflow/underflow solutions above have the following drawbacks: (i) they do not provide antialias filtering when underflow/overflow occurs (ii) they add a considerable number of bits to the communications interface.

FIG. 5C is a diagram illustrating a system that can handle the overflow/underflow problem with uninterrupted antialias filtering service at a penalty of as little as two bits per signal. This system operates by applying a closed loop rate feedback nulling scheme to the signal 570. Tis technique prevents signal 570 from ever overflowing or underflowing by summing an appropriate artificial bias rate to the angular rate 302 at summer 312, and communicating this information through buffer 410 so that the effects of this artificial bias rate can be stripped out in the user processing.

The preferred implementation is to use only two predetermined values of artificial bias rate, one positive (+B 590) and one negative (−B 591) applied to summing junction 523. The polarity of the currently active artificial bias rate 521 is determined by an element implementing a sgn(x) function 592 and communicated to the bias correction module 511 by a single sign bit added to buffer 410B. To convey the number of high rate samples (samples at the rate f_{process}^{gyro}) that the current sign of artificial bias rate has been active, the sense of the artificial bias rate is only changed when the output of a high rate sample counter 593 (producing the counter value N) used in the computation of the integral of θ 570 rolls over, and the counter value N is also accounted for in the buffer 410C. As shown in FIG. 5C, the high sample rate counter 593 can be implemented by a constant “1” input 594 to integrator formed by summing junction 595 and delay element 596. The inclusion of high sample rate counter 593 in the interface need not be a penalty for this scheme, since this signal is already required in implementations using Equation (4).

The magnitudes of the bias rates are chosen to be larger in magnitude than the expected range of magnitudes of the angular rate signal 302, in order that the bias rates have enough authority to prevent the angular rate signal from increasing the magnitude of signal 570. There are advantages to choosing a bias rate whose binary representation has only one nonzero bit, such as convenient digital hardware representation and some simplifications in the user computations to strip out the signal. The sign of the bias rates can be simply chosen to be the opposite sign from the sign of the signal 570 at the time the modulo counter N rolls over to zero. To ensure that the user can determine which sense of the bias is present, the range of the modulo counter is usefully chosen to be large enough so that no more then one modulo counter rollover occurs between three consecutive user samples (at fₛ).

An exemplary approach to processing with the bias rate signal is to modify the processing after summing junction 316 so that the signal 320 is identical to that that would result if the bias signal were zero, and there were no overflows/underflows in signal 570. Since the bias signal is manipulated to ensure there are no underflows/overflows in signal 570, the processing after summing junction 316 need only be modified so as to remove the effect of the bias rate signal.

The effect of the bias rate signal on the computation of the delta angle 320 can be corrected by subtracting the effect of the bias after the summing junction 316. If we define these terms:

B=the magnitude of the artificial bias rate (denoted 517 in FIG. 5C);

X(k)=the value of the k^{th} sample of signal 574;

S(k)=the sign of the artificial bias rate at the time of X(k) (denoted 599 in FIG. 5C);

N(k)=the value of the modulo counter 593 at the time of X(k) (denoted 507 in FIG. 5C);

Nₘₐₓ=the modulo range for N(k) (denoted 519 in FIG. 5c);

F(i)=the cumulative effect of the artificial bias rate 521 on X(i)-X(k-2);

C(k)=the correction for the artificial bias rate for the k^{th} sample of signal 320 (denoted 525 in FIG. 5C).

One useful observation is that using divider 513, signal 576 can be normalized by the back difference of N(k) 507 to ensure that signal_320(k) (the k^{th} value of the delta angle signal 320) is independent of X(k-2)) and signal_570(k-2) (the k-2^{th} value of signal 570). Note that:

$$\begin{matrix}signal\_ 320 = signal\_ 315 ( k ) - C ( k ) \\ where & Equation ( 6 ) \\ C ( k ) = \frac{F ( k ) - F ( k - 1 )}{N ( k ) \_ - N ( k - 1 )} - \frac{F ( k - 1 ) - F ( k - 2 )}{N ( k - 1 ) - N ( k - 2 )} ; & Equation ( 7 )\end{matrix}$$

and where signal_315(k) is the k^{th} value of the signal from back difference 314.

Since F(k-2)=0 by definition of F(i), this reduces to:

$$C ( k ) = \frac{F ( k ) - F ( k - 1 )}{N ( k ) - N ( k - 1 )} - \frac{F ( k - 1 )}{N ( k - 1 ) - N ( k - 2 )} \qquad Equation ( 8 )$$

In equations (7) and (8) above, the differences in N(i) shown in the denominators can be used to account for rollovers in N(i), for example, by doing the computations in two's complement arithmetic.

Without correction, the delta angle signal 320 depends on three user samples: X(k), X(k-1), and X(k-2). To correct for the artificial bias rate signal 521, the behavior of the artificial bias rate signal 521 over that time period should be considered.

Generally speaking, the processing must handle changes in the value of the artificial bias rate signal 521. The simplest case that is sufficiently general is that the artificial bias rate magnitude, B, is chosen to ensure that the artificial bias rate signal 521 will change value no more than once in this time period. This leads to the recommendation that the range of the modulo counter 593 is usefully chosen to be large enough so that no more then one modulo counter rollover occurs between three consecutive samples at fₛ. In this case C(k) 525 is a function of B, S(k), S(k-1), S(k-2), N(k), N(k-1), N(k-2),and Nₘₐₓ.

For readability, define the following abbreviated symbols:

$$F = F ( k )$$

$$F 1 = F ( k - 1 )$$

$$N - N ( k )$$

$$N 1 = N ( k - 1 )$$

$$N 2 = N ( k - 2 )$$

$${N}_{d} = {N}_{max} - N 2$$

$$S = S ( k )$$

$$S 1 = S ( k - 1 )$$

$$S 2 = S ( k - 2 )$$

$$B 2 = \frac{B}{2}$$

Using the abbreviated notation, our earlier equation becomes:

$$C ( k ) = \frac{F - F 1}{N - N 1} - \frac{F 1}{N 1 - N 2} \qquad Equation ( 9 )$$

There are three possible sets of values for S, S1, and S2: (a) S2=S1=S, (b) S2=S1≠S, and (c) S2≠S1=S

In case (a):

$$\begin{matrix}F 1 = \frac{B * S 2 ( N 1 - N 2 ) ( N 1 - N 2 + 1 )}{2} & Equation ( 10 ) \\ F = \frac{B * S 2 * ( N - N 2 ) ( N - N 2 + 1 )}{2} & Equation ( 11 )\end{matrix}$$

In case (b):

$$\begin{matrix}F 1 = \frac{B * S 2 * ( N 1 - N 2 ) ( N 1 - N 2 + 1 )}{2} & Equation ( 12 ) \\ F = B [ S 2 * {N}_{d} ( \frac{{N}_{d} + 1}{2} + N ) + \frac{S * N * ( N + 1 )}{2} ] & Equation ( 13 )\end{matrix}$$

In case (c):

$$\begin{matrix}F 1 = B [ \begin{matrix}S 2 * {N}_{d} ( \frac{{N}_{d} + 1}{2} + N 1 ) + \\ \frac{S * N 1 * ( N 1 + 1 )}{2}\end{matrix} ] & Equation ( 14 ) \\ F = B [ \begin{matrix}S 2 * {N}_{d} ( \frac{{N}_{d} + 1}{2} + N ) + \\ \frac{S * N * ( N + 1 )}{2}\end{matrix} ] & Equation ( 15 )\end{matrix}$$

The foregoing equations can be computed in the bias correction module 511 to produce C(k) 525. Again, in the above equations, wherever differences of N, N1 and N2 are computed, such as (N−N1), (N1−N2), (N−N2), these differences should be computed in modulo arithmetic (such as two's complement) to ensure that the correct results for these differences are obtained in the event of counter rollover.

The form of the equations above were chosen for clarity. For implementation, one may want to reformulate the equations for efficiency. All of the equations describing F1 and F can be set up for efficient implementation in fixed point arithmetic. As an illustration, in case (c), if B is chosen so that

$$B 2 = \frac{B}{2}$$

is an integer power of two, then the equation for F becomes one that can be evaluated efficiently in integer arithmetic up to the final scaling with B2, which will in turn just be a shift operation, as described below:
F=B2[S2*N_{d}[(N_{d}+1)+(2*N)]+S*N*(N+1)] Equation (16)

Similarly, the multiplication of B2 can be moved out of the calculations for F and F1, and applied as the final step in the calculation of C(k) 525. Further algebraic simplifications can also be applied.

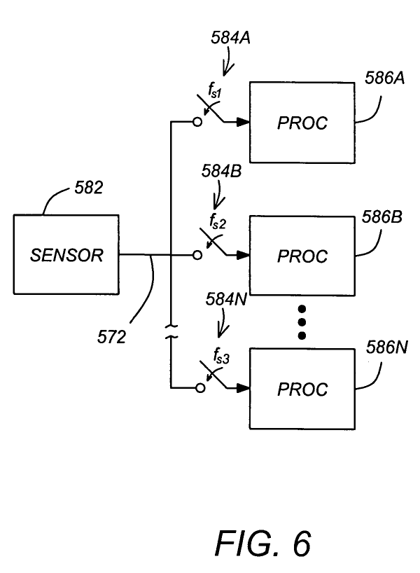

FIG. 6 is a diagram illustrating another embodiment of the present invention. In this embodiment, the second intermediate signal 572 (optionally, after buffering) from the sensor 582 is sampled by a plurality of samplers 584A-584N, each of which can be sampling at a different rate than the other samplers. The sampled signals are provided to a plurality of processors 586A-586N. As before, samplers 584A-584N can be implemented the processors 586A-586N themselves. The sensor 582, samplers 584A-584N, and processors 586A-586N are otherwise analogous in structure and funtion to the sensor 582, sampler 584, and processor 586 illustrated in FIG. 5B. This embodiment produces filtered sensor measurements having characteristics (sampling rate, zeros and poles) that can be individually tailored by processor 586A-586N via appropriate selection of the sampling rate of the samplers samplers 584A-584N and the characteristics of the differentiator 554 and/or integrator 314 in each processor.

### Conclusion

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A method of anti-alias filtering sensor measurements, comprising the steps of:
digitally integrating the sensor measurements at a first processing rate to produce a first intermediate signal;
digitally integrating the first intermediate signal at the first processing rate to produce a second intermediate signal;
sampling the second intermediate signal at a second processing rare to produce a third intermediate signal;
digitally differentiating the third intermediate signal at the second processing rate to produce a fourth intermediate signal; and
digitally differentiating the fourth intermediate signal at the second processing rate to produce filtered sensor measurements;
wherein the steps of digitally integrating the sensor measurements at a first processing rate to produce a first intermediate signal and digitally integrating the fist intermediate signal at the first processing rate to produce a second intermediate signal are performed by the sensor; and
wherein the steps of digitally differentiating the third intermediate signal at the second processing rate to produce a fourth intermediate signal, and digitally differentiating the fourth intermediate signal at the second processing rate to produce a filtered sensor measurement are performed by a processor external to the sensor.

2. The method of claim 1, wherein:
the step of digitally differentiating the third intermediate signal at the second processing rate to produce a fourth intermediate signal comprises the step of digitally back differencing the third intermediate signal at the second processing rate to produce the fourth intermediate signal; and
the step of digitally differentiating the fourth intermediate signal at the second processing rate to produce filtered sensor measurements comprises the step of digitally back differencing the fourth intermediate signal at the second processing rate to produce filtered sensor measurements.

3. The method of claim 1, wherein the first processing rate is greater than the second processing rate.

4. The method of claim 3, wherein the first processing rate is a sensor output update frequency.

5. The method of claim 3, wherein the second processing rate is a flight computer processing rate.

6. The method of claim 1, wherein the step of sampling the second intermediate signal is performed by the processor external to the sensor.

7. The method of claim 1, wherein the sensor is a gyro.

8. The method of claim 1, further comprising the step of scaling the sampled second intermediate signal.

9. A system for anti-alias filtering sensor measurements, comprising:
a sensor, for measuring a dynamic parameter subject to aliasing, the sensor including a first digital integrator for integrating sensor measurements at a first processing rate;
an anti-aliasing filter, having a second digital integrator implemented in the sensor and communicatively coupled to the first digital integrator second digital integrator, operating at the first processing rate;
a sampler, communicatively coupled to the second digital integrator, operating at a sampling rate;
a first differentiator, external to the sensor, operating at a second processing rate; and
a processor external to the sensor, having a second differentiator communicatively coupled to the differentiator.

10. The system of claim 9, wherein the first differentiator comprises a digital back-differencer and the second differentiator comprises a second digital back-differencer.

11. The system of claim 9, wherein the second processing rate is equal to the sampling rate.

12. The system of claim 9, wherein the second digital integrator is implemented in the sensor.

13. The system of claim 12, wherein the first back differencer is implemented m the navigation processor.

14. The system of claim 9, wherein the first processing rate is greater than the second processing rate.

15. The system of claim 14, wherein the first processing rate is a sensor update frequency.

16. The system of claim 9, wherein the second processing rate is a navigation computer processing rate.

17. The system of claim 9, wherein the sensor is a gyro.

18. An apparatus for anti-alias filtering sensor measurements, comprising:
a sensor, comprising means for digitally integrating the sensor measurements at a first processing rate to produce a first intermediate signal;
means for digitally integrating the first intermediate signal at the first processing rate to produce a second intermediate signal;
means for sampling the second intermediate signal at a second processing rate to produce a third intermediate signal;
a processor external to the sensor, comprising
means for digitally differentiating the third intermediate signal at the second processing rare to produce a fourth intermediate signal; and
means for digitally differentiating the fourth intermediate signal at the second processing rate to produce the filtered sensor measurements.

19. The apparatus of claim 18, wherein:
the means for digitally differentiating the third intermediate signal at the second processing rate to produce a sour intermediate signal is comprises means for digitally back differencing the third intermediate signal at the second processing rate to produce the fourth intermediate signal; and
the means for digitally differentiating the fourth intermediate signal at the second processing rate to produce altered sensor measurements comprises means for digitally back differencing the fourth intermediate signal at the second processing rate to produce filtered sensor measurements.

20. The apparatus of claim 18, wherein the first processing rate is greater than the second processing rate.

21. The apparatus of claim 20, wherein the first processing rate is a sensor output update frequency.

22. The apparatus of claim 20, wherein the second processing rate is a flight computer processing rate.

23. The apparatus of claim 18, wherein the means for sampling the second intermediate signal at a second processing rate to produce a third intermediate signal comprises the processor.

24. The apparatus of claim 18, wherein the sensor is a gyro.

25. The apparatus of claim 18, further comprising the step of scaling the sampled second intermediate signal.

26. A system for anti-alias filtering sensor measurements, comprising:
a sensor, for measuring a dynamic parameter subject to aliasing, the sensor including
a first digital integrator for integrating sensor measurements at a first processing rate to produce a first intermediate signal;
a second digital integrator, for integrating the fist intermediate signal to produce a second intermediate signal, the second digital integrator operating at the first processing rate;
a plurality of samplers communicatively coupled to the second digital integrator, each of the samplers sampling the second intermediate signal to produce a third intermediate signal; and
a plurality of processors, each of the plurality of processors external to the sensor and coupled to an associated one of the plurality of samplers, each of the plurality of processors comprising a first digital differentiator and a second digital differentiator for multiply digitally differentiating the sampled second intermediate signal to produce filtered sensor measurements;
wherein the first digital differentiator and second digital differentiator of each of the plurality of processors and associated one of the coupled samplers, together with the first digital integrator and second digital integrator of the sensor, form an anti-aliasing filter.

27. The system of claim 26, wherein at least one of the plurality of samplers sample the second intermediate signal at a different sampling rate than the other of the plurality of samplers.
